(19) United States
(12) Patent Application Publication
(10) Pub. No.: US 2015/0348491 A1
(43) Pub. Date: Dec. 3, 2015

(54) ROBUST DRIVER WITH MULTI-LEVEL OUTPUT

(71) Applicant: QUALCOMM MEMS Technologies, Inc., San Diego, CA (US)

(72) Inventors: Cheonhong Kim, San Diego, CA (US); Edward Keat Leem Chan, San Diego, CA (US); Murali Krishna Raju Vegiraju, Dublin, CA (US); Tallis Young Chang, San Diego, CA (US)

(21) Appl. No.: 14/476,380

(22) Filed: Sep. 3, 2014

Related U.S. Application Data
(60) Provisional application No. 62/005,373, filed on May 30, 2014.

(51) Int. Cl. G09G 5/00; G06T 1/60; G09G 5/18

(52) U.S. Cl. CPC G09G 5/00; G09G 5/18; G06T 1/60; G09G 2330/021

(57) ABSTRACT

This disclosure provides systems, methods and apparatus for a driver circuit providing a selection of a voltage among multiple voltages at its output. In one aspect, the static power consumption of the circuit may be reduced by employing a power supply scheme that allows for a reduction in sub-threshold leakage current.

### PRIORITY DATA

This patent document claims priority to co-pending and commonly assigned U.S. Provisional Patent Application No. 62/005,373, titled “Robust Driver with Three-Level Output”, by Kim et al., filed on May 30, 2014 (Attorney Docket No. 144795P1/QUALP254P), which is hereby incorporated by reference in its entirety and for all purposes.

### TECHNICAL FIELD

This disclosure relates to electromechanical systems and devices. More specifically, the disclosure relates to a reduced-leakage driver circuit providing multiple voltage levels for electromechanical systems and devices, such as a display using interferometric modulators (IMODs).

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

In some implementations, a movable element of the IMOD may be moved to a particular position from a starting point and under a particular application of voltages to electrodes of the IMOD. Row driver circuits and column driver circuits may provide a variety of voltages to bias the electrodes of the IMOD to particular voltages based on the desired position of the movable element. However, the transistors used to implement the driver circuits may have a high sub-threshold leakage contributing to static power consumption.

### SUMMARY

The systems, methods and devices of this disclosure each have several innovative aspects, no single one of which is solely responsible for the desirable attributes disclosed herein.

One innovative aspect of the subject matter described in this disclosure can be implemented in a circuit including output circuitry including a first output driver, a second output driver, and a third output driver, each of the output drivers coupled together to define an output node, the first output driver capable of driving the output node to a first voltage associated with a first voltage source, the second output driver capable of driving the output node to a second voltage associated with a second voltage source, and the third output driver capable of driving the output node to a third voltage associated with a third voltage source; and selection circuitry capable of selecting one of the first output driver, the second output driver, and the third output driver to drive the output node, the selection circuitry receiving a first input signal, a second input signal, a first trigger, and a second trigger, the selection circuitry capable of selecting the output driver to drive the output node based on the first input signal, the second input signal, the first trigger, and the second trigger.

In some implementations, the output circuitry can include the first output driver having a first switch, the first switch having a control terminal, a first terminal and a second terminal, the first terminal coupled with a first voltage source; the second output driver having a second switch, the second switch having a control terminal, a first terminal and a second terminal, the first terminal coupled with a second voltage source, the second terminal of the first switch coupled with the second terminal of the second switch to define the output node; and the third output driver having a third switch, the third switch having a control terminal, a first terminal, and a second terminal, the first terminal coupled with a third voltage source, the second terminal coupled with the output node.

In some implementations, the selection circuitry can include a fourth switch having a control terminal, a first terminal, and a second terminal, the first terminal coupled with a fourth voltage source, the second terminal coupled with the control terminal of the first switch, and the control terminal of the third switch coupled to receive the first trigger signal, a fifth switch having a control terminal, a first terminal, and a second terminal, the first terminal coupled with the fourth voltage source, the second terminal coupled with the control terminal of the second switch, and the control terminal of the fourth switch coupled to receive the first trigger signal, and a sixth switch having a control terminal, a first terminal, and a second terminal, the first terminal coupled with the fourth voltage source, the second terminal coupled with the control terminal of the third switch, and the control terminal coupled to receive the second trigger signal.

In some implementations, the circuit can include a display including a plurality of display units, wherein a voltage at the output node of the output circuit is provided to an electrode of at least one display unit; a processor that is capable of communicating with the display, the processor being configured to process image data; and a memory device that is capable of communicating with the processor.

In some implementations, the circuit can include a controller capable of sending at least a portion of the image data to the driver circuit.

In some implementations, the circuit can include an image source module capable of sending the image data to the processor, wherein the image source module comprises at least one of a receiver, transceiver, and transmitter.

In some implementations, the circuit can include an input device capable of receiving input data and to communicate the input data to the processor.

Another innovative aspect of the subject matter disclosed herein can be implemented in a circuit having output circuitry including: a first switch having a control terminal, a first terminal and a second terminal, the first terminal coupled with a first voltage source, a second switch having a control terminal, a first terminal and a second terminal, the first terminal coupled with a second voltage source, the second terminal of the first switch coupled with the second terminal of the second switch to define an output node, and a third switch having a control terminal, a first terminal, and a second terminal, the first terminal coupled with a third voltage source, the second terminal coupled with the output node; and selection circuitry including: a fourth switch having a control terminal, a first terminal, and a second terminal, the first terminal coupled with a fourth voltage source, the second terminal coupled with the control terminal of the first switch, and the control terminal of the third switch coupled to receive a first trigger signal, a fifth switch having a control terminal, a first terminal, and a second terminal, the first terminal coupled with the fourth voltage source, the second terminal coupled with the control terminal of the second switch, and the control terminal of the fourth switch coupled to receive the first trigger signal, and a sixth switch having a control terminal, a first terminal, and a second terminal, the first terminal coupled with the fourth voltage source, the second terminal coupled with the control terminal of the third switch, and the control terminal coupled to receive a second trigger signal.

In some implementations, the first voltage source can be capable of providing a voltage higher than a voltage provided by the third voltage source, and the voltage provided by the third voltage source can be higher than a voltage provided by the second voltage source.

In some implementations, the voltage provided by the second voltage source can be higher than a voltage provided by the fourth voltage source.

In some implementations, the first trigger signal can be capable of providing a voltage between a first voltage and a second voltage, the first voltage higher than the voltage provided by the first voltage source, and the second voltage lower than the voltage provided by the fourth voltage source.

In some implementations, the second trigger signal can be capable of providing a voltage between a first voltage and a second voltage, the first voltage higher than the voltage provided by the first voltage source, and the second voltage lower than the voltage provided by the fourth voltage source.

In some implementations, the first voltage source can be capable of providing a voltage higher than a voltage provided by the third voltage source, the voltage provided by the third voltage source can be higher than a voltage provided by the second voltage source, and the voltage provided by the second voltage source can be higher than a voltage provided by the fourth voltage source.

In some implementations, the first trigger signal can be capable of providing a voltage between a first voltage and a second voltage, the first voltage higher than the voltage provided the first voltage source, and the second voltage can be lower than the voltage provided by the fourth voltage source.

In some implementations, the selection circuitry can include: a seventh switch having a control terminal, a first terminal, and a second terminal, the first terminal coupled with the control terminal of the first switch to define a first feedback node, and the control terminal coupled to receive the second trigger signal; an eighth switch having a control terminal, a first terminal, and a second terminal, the first terminal coupled to receive a first input signal, the second terminal coupled with the second terminal of the seventh switch, and the control signal coupled to receive the second trigger signal; and a ninth switch having a control terminal, a first terminal, and a second terminal, the first terminal coupled with a fifth voltage source, the second terminal coupled with the second terminals of the seventh switch and the eighth switch, and the control terminal coupled with the first feedback node.

In some implementations, the fifth voltage source can be capable of providing a voltage higher than a voltage provided by the first voltage source, the voltage provided by the first voltage source higher than a voltage provided by the third voltage source, the voltage provided by the third voltage source higher than a voltage provided by the second voltage source, and the voltage provided by the second voltage source higher than a voltage provided by the fourth voltage source.

In some implementations, the first trigger signal can be capable of providing a low voltage, the low voltage lower than the voltage provided by the fourth voltage source.

In some implementations, the selection circuitry can include: a tenth switch having a control terminal, a first terminal, and a second terminal, the first terminal coupled with the control terminal of the second switch to define a second feedback node, and the control terminal coupled to receive the second trigger signal; an eleventh switch having a control terminal, a first terminal, and a second terminal, the first terminal coupled to receive a second input signal, the second terminal coupled with the second terminal of the tenth switch, and the control signal coupled to receive the second trigger signal; and a twelfth switch having a control terminal, a first terminal, and a second terminal, the first terminal coupled with the fifth voltage source, the second terminal coupled with the second terminals of the tenth switch and the eleventh switch, and the control terminal coupled with the second feedback node.

In some implementations, the selection circuitry further includes: a thirteenth switch having a control terminal, a first terminal, and a second terminal, the first terminal coupled with the control terminal of the third switch, the second terminal coupled with the fifth voltage source, and the control terminal coupled to receive the first trigger signal.

Another innovative aspect of the subject matter disclosed herein can be implemented in a method including receiving a first trigger signal; providing, responsive to the first trigger signal, a first voltage at an output node of output circuitry, and the output node is electrically coupled to an electrode of a display unit; receiving a second trigger signal; and providing, responsive to the second trigger signal, a second voltage or a third voltage at the output node based on a first input signal and a second input signal.

In some implementations, the method can include selecting, by selection circuitry, the first voltage, second voltage, or third voltage to be provided at the output node, wherein the output circuitry can include: a first switch having a control terminal, a first terminal and a second terminal, the first terminal coupled with a first voltage source, a second switch having a control terminal, a first terminal and a second terminal, the first terminal coupled with a second voltage source, the second terminal of the first switch coupled with the second terminal of the second switch to define the output node, and a third switch having a control terminal, a first terminal, and a second terminal, the first terminal coupled with a third voltage source, the second terminal coupled with the output node; and wherein the selection circuitry includes: a fourth switch having a control terminal, a first terminal, and a second terminal, the first terminal coupled with a fourth voltage source, the second terminal coupled with the control terminal of the first switch, and the control terminal of the third switch coupled to receive the first trigger signal, a fifth switch having a control terminal, a first terminal, and a second terminal, the first terminal coupled with the fourth voltage source, the second terminal coupled with the control terminal of the second switch, and the control terminal of the fourth switch coupled to receive the first trigger signal, and a sixth switch having a control terminal, a first terminal, and a second terminal, the first terminal coupled with the third voltage source, the second terminal coupled with the control terminal of the third switch, and the control terminal coupled to receive the second trigger signal.

In some implementations, first input signal and the second input signal can provide a voltage between a fourth voltage and a fifth voltage, the first trigger signal and the second trigger signal can provide a voltage between the fourth voltage and a sixth voltage.

In some implementations, the fourth voltage can be higher than the second voltage, the second voltage can be higher than the first voltage, the first voltage is higher than the third voltage, the third voltage can be higher than the fifth voltage, and the fifth voltage can be higher than the sixth voltage.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIGS. 3A and 3B are schematic exploded partial perspective views of a portion of an electromechanical systems (EMS) package including an array of EMS elements and a backplate.

FIG. 4 is an example of a system block diagram illustrating an electronic device incorporating an IMOD-based display.

FIG. 5 is a circuit schematic of an example of a three-terminal IMOD.

FIG. 6 is a circuit schematic of a driver circuit.

FIG. 7 is a timing diagram for the driver circuit of FIG. 6.

FIG. 8A is an example of a system block diagram illustrating an output of a driver being used as a trigger for another driver.

FIG. 8B is another example of a system block diagram illustrating an output of a driver being used as a trigger for another driver.

FIG. 9 is an illustration of a transfer curve for I_{d} (drain current) vs. V_{gs} (gate-to-source voltage) for an exemplary NMOS transistor.

FIG. 10 is a flow diagram illustrating a method for providing a voltage at an output of a driver circuit.

FIGS. 11A and 11B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Active matrix flat panel displays such as active matrix liquid crystal displays, organic light emission displays, and interferometric modulator (IMOD) displays may use thin film transistors (TFTs) on glass substrates. The TFTs may be used to implement driver circuits for addressing display elements.

Amorphous oxide semiconductor TFTs, such as indium gallium zinc oxide (IGZO) TFTs, may be used to replace amorphous silicon and low temperature and polysilicon TFTs. In some implementations, the oxide semiconductor layer can include one or more of indium (In), gallium (Ga), zinc (Zn), hafnium (Hf), and tin (Sn). However, IGZO TFTs have a high sub-threshold leakage current (e.g., an unwanted drain current when the transistor gate voltage is zero). Preferably, sub-threshold leakage current should be reduced to ensure a circuit operates properly and reduce static power consumption.

Some implementations of the subject matter described in this disclosure reduce leakage current in a driver circuit providing one of three voltage levels at its output. Leakage contributing to static power consumption may be reduced by employing a power supply scheme used to bias each transistor of the driver circuit.

Particular implementations of the subject matter described in this disclosure can be implemented to realize one or more of the following potential advantages. Reducing static power consumption may lower power usage and, for example, increase the battery life of devices including display devices such as tablets, laptops, phones, e-book readers, and wearable devices (e.g., smart watches). Employing the proper power supply scheme may improve the robustness of the driver circuit operation.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

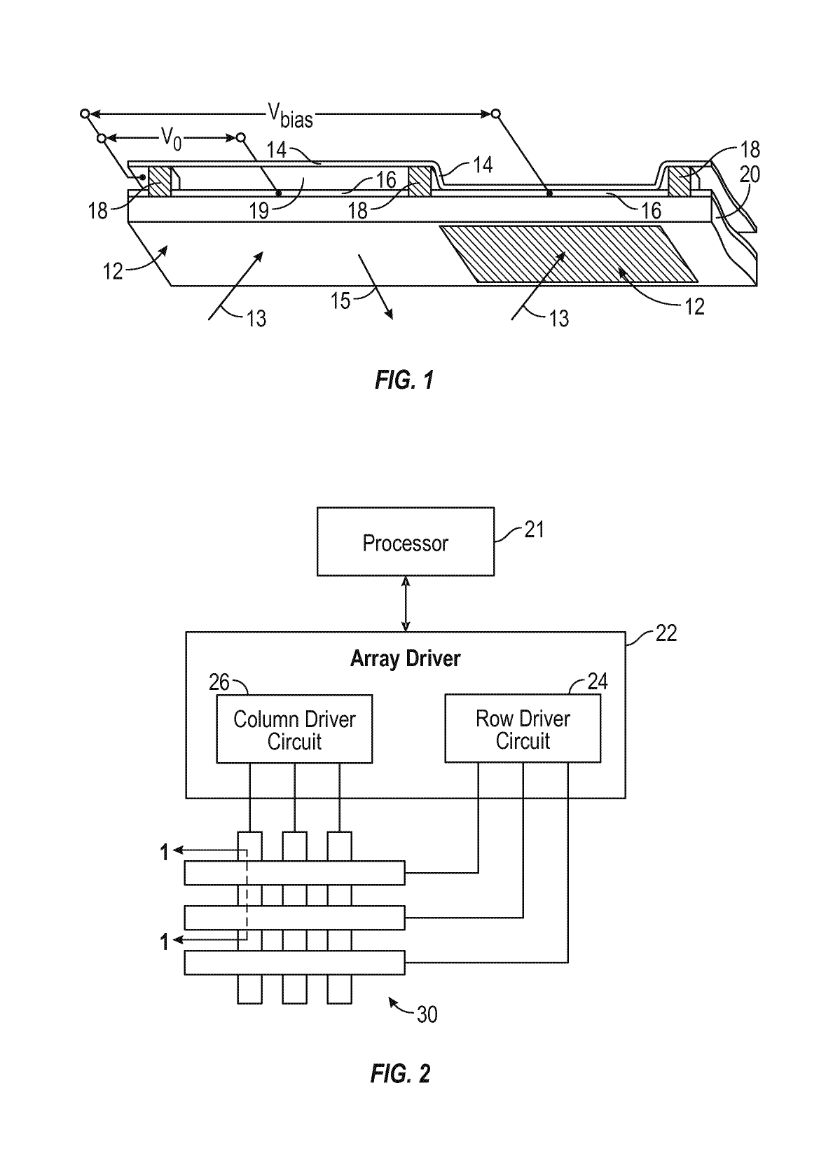

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

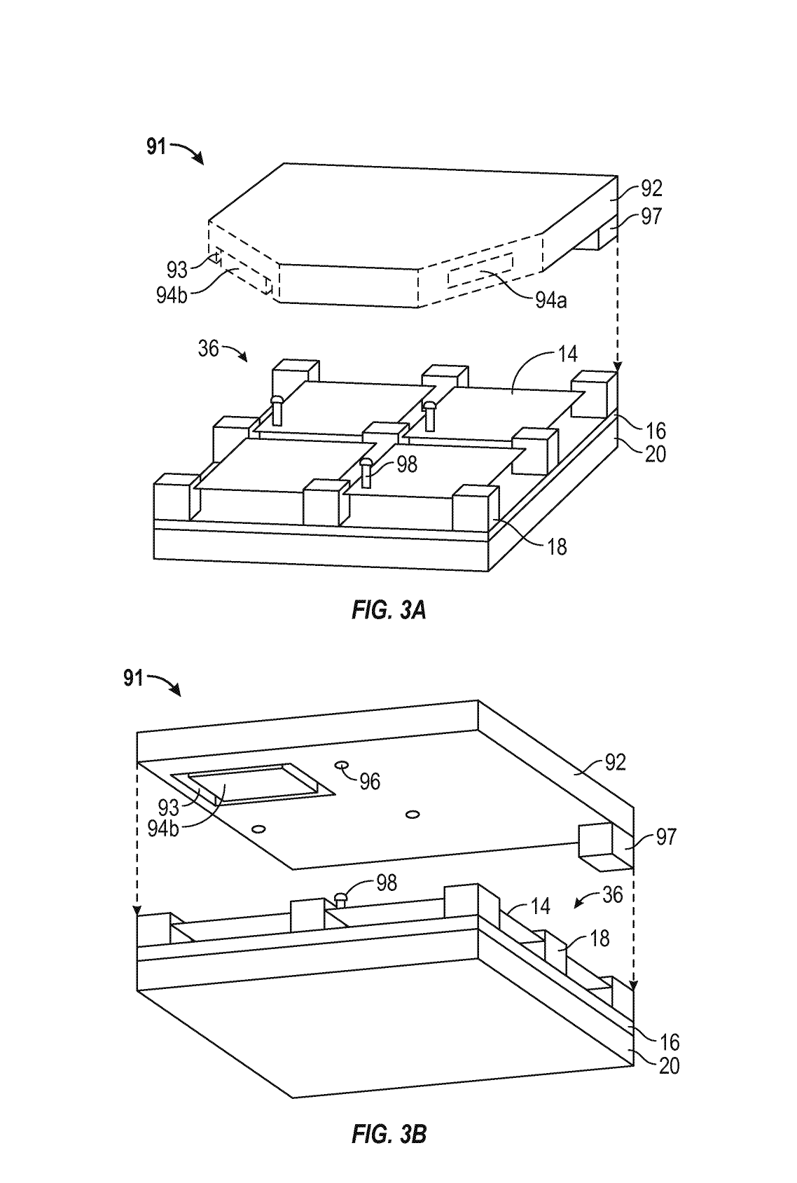

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

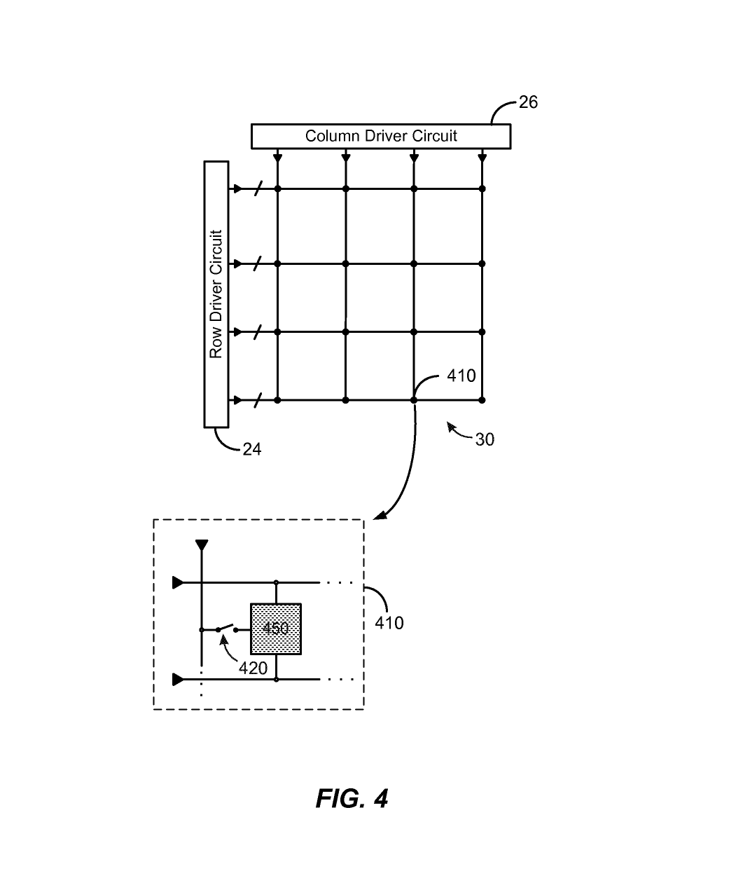

FIGS. 3A and 3B are schematic exploded partial perspective views of a portion of an EMS package 91 including an array 36 of EMS elements and a backplate 92. FIG. 3A is shown with two corners of the backplate 92 cut away to better illustrate certain portions of the backplate 92, while FIG. 3B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 3A and 3B, the backplate 92 can include one or more backplate components 94a and 94b, which can be partially or wholly embedded in the backplate 92. As can be seen in FIG. 3A, backplate component 94a is embedded in the backplate 92. As can be seen in FIGS. 3A and 3B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

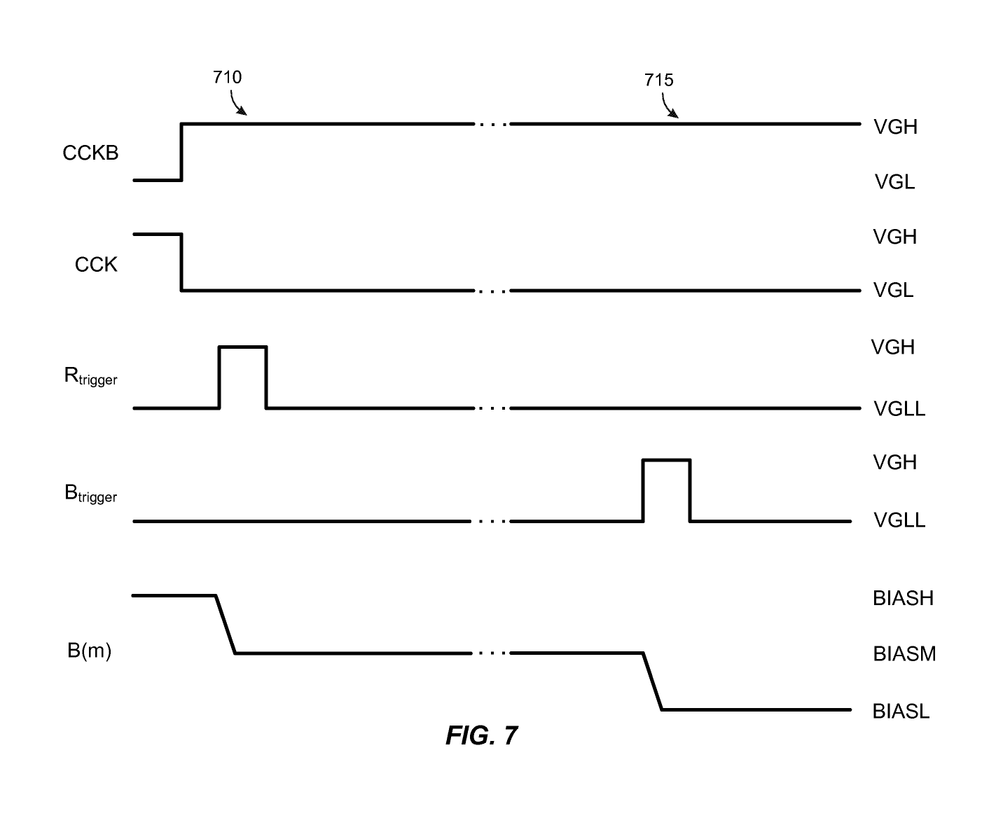

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 6B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 6A and 6B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 3A and 3B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

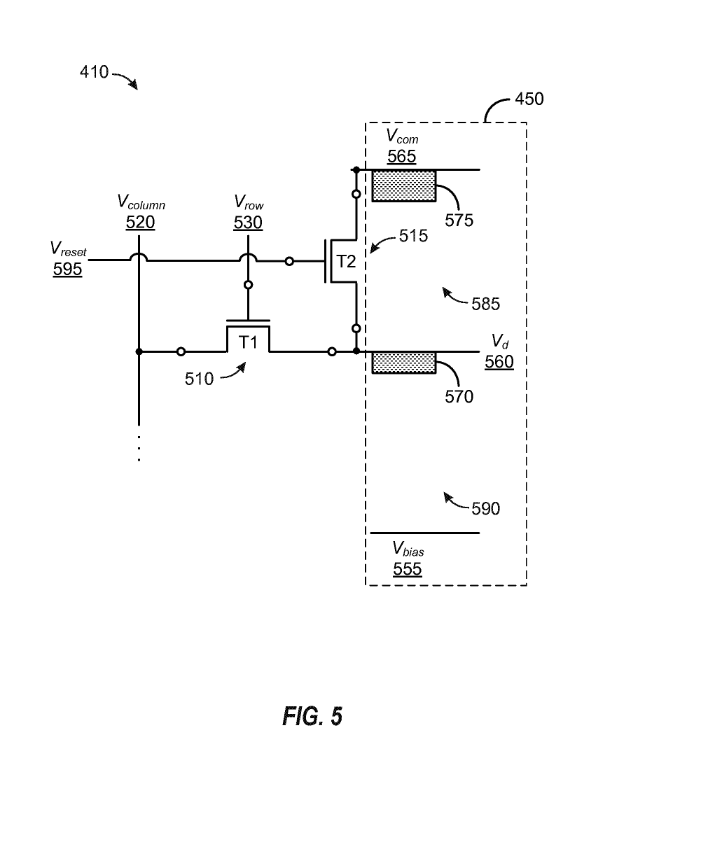

FIG. 4 is an example of a system block diagram illustrating an electronic device incorporating an IMOD-based display. FIG. 4 depicts an implementation of row driver circuit 24 and column driver circuit 26 of array driver 22 that provide signals to display array or panel 30, as previously discussed.

The implementation of display module 410 in display array 30 may include a variety of different designs. As an example, display module 410 in the fourth row may include switch 420 and display unit 450. Display module 410 may be provided a row signal, reset signal, bias signal, and a common signal from row driver circuit 24. Display module 410 may also be provided a data signal from column driver circuit 26. In some implementations, display unit 450 may be coupled with switch 420, such as a transistor with its gate coupled to the row signal and its drain coupled with the column signal. Each display unit 450 may include an IMOD display element as a pixel.

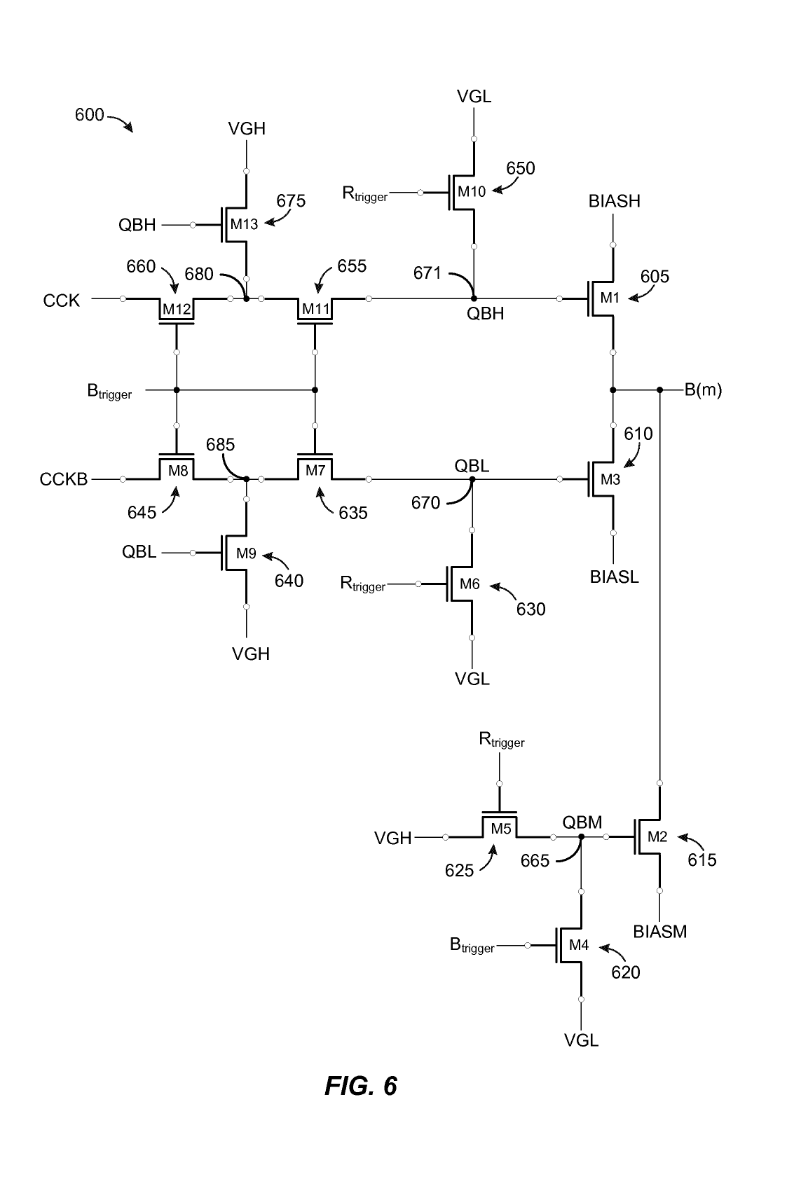

Some IMODs are three-terminal devices that use a variety of signals. FIG. 5 is a circuit schematic of an example of a three-terminal IMOD. In the example of FIG. 5, display module 410 includes display unit 450 (e.g., an IMOD). The circuit of FIG. 5 also includes switch 420 of FIG. 4 implemented as an n-type metal-oxide-semiconductor (NMOS) transistor T1 510. The gate of transistor T1 510 is coupled to V_{row} 530 (i.e., a control terminal of transistor T1 510 is coupled to V_{row} 530 providing a row select signal), which may be provided a voltage by row driver circuit 24 of FIG. 4. Transistor T1 510 is also coupled to V_{column} 520, which may be provided a voltage by column driver circuit 26 of FIG. 4. If V_{row} 530 (providing a row select signal) is biased to turn transistor T1 510 on, the voltage on V_{column} 520 may be applied to V_{d} electrode 560. The circuit of FIG. 5 also includes another switch implemented as an NMOS transistor T2 515. The gate (or control) of transistor T2 515 is coupled with Vᵣₑₛₑₜ 595. The other two terminals of transistor T2 515 are coupled with V_{com} electrode 565 and V_{d} electrode 560. When transistor T2 515 is biased to turn on (e.g., by a voltage of a reset signal on Vᵣₑₛₑₜ 595 applied to the gate of transistor T2 515), V_{com} electrode 565 and V_{d} electrode 560 may be shorted together.

Display unit 450 may be a three-terminal IMOD including three terminals or electrodes: V_{bias} electrode 555, V_{d} electrode 560, and V_{com} electrode 565. Display unit 450 may also include movable element 570 and dielectric 575. Movable element 570 may include a mirror, as previously discussed. Movable element 570 may be coupled with V_{d} electrode 560. Additionally, air gap 590 may be between V_{bias} electrode 555 and V_{d} electrode 560. Air gap 585 may be between V_{d} electrode 560 and V_{com} electrode 565. In some implementations, display unit 450 may also include one or more capacitors. For example, one or more capacitors can be coupled between V_{d} electrode 560 and V_{com} electrode 565 and/or between V_{bias} electrode 555 and V_{d} electrode 560.

Movable element 570 may be positioned at various points between V_{bias} electrode 555 and V_{com} electrode 565 to reflect light at a specific wavelength. In particular, voltages applied to V_{bias} electrode 555, V_{d} electrode 560, and V_{com} electrode 565 may determine the position of movable element 570.

Voltages for Vᵣₑₛₑₜ 595, V_{column} 520, V_{row} 530, V_{com} electrode 565, and V_{bias} electrode 555 may be provided by driver circuits such as row driver circuit 24 and column driver circuit 26. In some implementations, V_{com} electrode 565 may be coupled to ground rather than driven by row driver circuit 24 or column driver circuit 26.

FIG. 6 is a circuit schematic of a driver circuit. Driver circuit 600 of FIG. 6 may be a row driver module in row driver circuit 24 and may provide a voltage to V_{bias} electrode 555 of display unit 450.

Driver circuit 600 of FIG. 6 includes thirteen switches implemented as thirteen NMOS transistors M1 605, M2 615, M3 610, M4 620, M5 625, M6 630, M7 635, M9 640, M8 645, M10 650, M11 655, M12 660, and M13 675. In some implementations, the circuit may be implemented with PMOS transistors or a combination of NMOS and PMOS transistors. In other implementations, other types of transistors or components may be used.

In FIG. 6, driver circuit 600 includes a variety of inputs and outputs: CCK, CCKB, R_{trigger}, B_{trigger}, output B(m), and power supplies providing voltage sources for BIASH, BIASM, BIASL, VGH, and VGL. Input signals CCK and CCKB may have a high voltage of VGH and a low voltage of VGL. R_{trigger} and B_{trigger} may have a high voltage of VGH and a low voltage of VGLL (a power supply providing a voltage lower than VGL, as discussed below). However, in other implementations, R_{trigger} and B_{trigger} may have a low voltage of VGL rather than VGLL. B(m) may be driven to BIASH, BIASM, or BIASL. In some implementations, CCK and CCKB may be inverted clocks (i.e., when one is high, the other is low, and vice versa).

The power supplies used by driver circuit 600 may follow a particular scheme. In the power supply scheme, the voltages of the power supplies may decrease, in order, from VGH (i.e., the power supply providing the highest voltage), BIASH, BIASM, BIASL, VGL, and VGLL (i.e., the power supply providing the lowest voltage). For example, VGH may be 16 volts (V), BIASH may be 8 V, BIASM may be ground (e.g., 0 V), BIASL may be −8 V, VGL may be −12 V, and VGLL may be −16 V.

In FIG. 6, an output stage includes driver transistors M1 605, M2 615, and M3 610 coupled together to define an output node providing output B(m) which may be provided to V_{bias} electrode 555 of display unit 450. When transistor M1 605 is turned on, output B(m) may be provided BIASH (e.g., 8 V). When M2 615 is turned on, output B(m) may be provided BIASM (e.g., 0 V). When M3 610 is turned on, output B(m) may be provided BIASL (e.g., −8 V). Accordingly, output B(m) may be driven to BIASH, BIASM, or BIASL based on which of driver transistors M1 605, M2 615, and M3 610 is turned on. That is, in FIG. 6, the driver transistors provide one of three different voltage levels to output B(m).

Each of the driver transistors is associated with a selection circuit to turn on the corresponding driver transistor to provide one of the three voltages to output B(m). For example, the gate, or control, of transistor M2 615 (i.e., the driver transistor providing BIASM) is coupled with terminals of transistors M4 620 and M5 625 to define QBM node 665. The gate of transistor M4 620 is coupled with B_{trigger}. Transistor M4 620 is also coupled with VGL. The gate of transistor M5 625 is coupled with R_{trigger}. Transistor M5 625 is also coupled with VGH.

For transistor M1 605 (i.e., the driver transistor providing BIASH), the gate is coupled with transistors M10 650 and M11 655 to define a feedback node QBH node 671 (i.e., QBH node 671 is also provided to the gate of transistor M13 675). The gate of transistor M10 650 is coupled with R_{trigger}. The other terminal of transistor M10 650 is coupled with VGL. The gate of transistor M11 655 is coupled with B_{trigger}. The other terminal of transistor M11 655 is coupled with transistors M12 660 and M13 675 to define node 680. The gate of transistor M13 675 is coupled with QBH node 671. The other terminal of transistor M13 675 is coupled with VGH. Lastly, the gate of transistor M12 660 is also coupled with B_{trigger}. The other terminal of transistor M12 660 is coupled with CCK.

For transistor M3 610 (i.e., the driver transistor providing BIASL), the gate is coupled with transistors M6 630 and M7 635 to define a feedback node QBL node 670 (i.e., QBL node 670 is also provided to the gate of transistor M9 640). The gate of transistor M6 630 is coupled with R_{trigger}. The other terminal of transistor M6 630 is coupled with VGL. The gate of transistor M7 635 is coupled with B_{trigger}. The other terminal of transistor M7 635 is coupled with transistors M8 645 and M9 640 to define node 685. The gate of transistor M9 640 is coupled with QBL node 670. The other terminal of transistor M9 640 is coupled with VGH. Lastly, the gate of transistor M8 645 is also coupled with B_{trigger}. The other terminal of transistor M8 645 is coupled with CCKB.

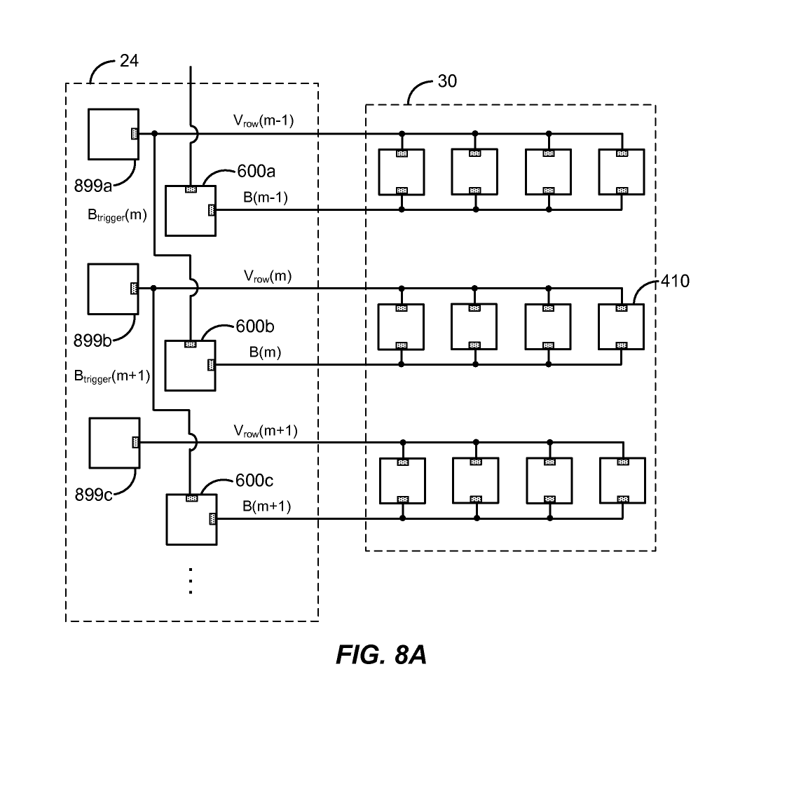

FIG. 7 is a timing diagram for the driver circuit of FIG. 6. In FIG. 7, at time 710, CCKB is at VGH (e.g., 16 V), CCK is at VGL (e.g., −12 V), R_{trigger} is at VGH (e.g., 16 V), and B_{trigger} is at VGLL (e.g., −16 V). B(m) transitions to BIASM (e.g., 0 V) based on the preceding voltages. In particular, since B_{trigger} is at VGLL (e.g., −16 V), transistors M7 635, M8 645, M11 655, and M12 660 are turned off. Since R_{trigger} is at VGH (e.g., 16 V) and transistors M7 635, M8 645, M11 655, and M12 660 are turned off, transistors M6 630 and M10 650 are turned on, and therefore, QBL node 670 and QBH node 671 are both driven to VGL (e.g., −12 V). Since QBL node 670 is at VGL, transistor M3 610 is turned off. Likewise, since QBH node 671 is at VGL, transistor M1 605 is also turned off.

However, transistor M2 615 is turned on to drive output B(m) to BIASM (e.g., 0 V). Since B_{trigger} is at VGLL (e.g., −16 V), transistor M4 620 is turned off. Since R_{trigger} is at VGH (e.g., 8 V), transistor M5 625 is turned on to provide VGH (e.g., 8 V) to QBM node 665 and turn on transistor M2 615. Since transistor M2 615 is turned on, BIASM (e.g., 0 V) is provided to output B(m).

Next, at time 715, CCKB is at VGH (e.g., 16 V), CCK is at VGL (e.g., −12 V), R_{trigger} is at VGLL (e.g., −16 V), and B_{trigger} is at VGH (e.g., 16 V). B(m) transitions to BIASL (e.g., −8 V) based on the preceding voltages. In particular, since R_{trigger} is at VGLL (e.g., −16 V), transistors M5 625, M6 630, and M10 650 are turned off. Since B_{trigger} is at VGH (e.g., 16 V), transistors M4 620, M7 635, M8 645, M11 655, and M12 660 are turned on. Since transistor M4 620 is turned on, QBM node 665 is driven to VGL (e.g., −12 V), and therefore, transistor M2 615 is turned off (i.e., output B(m) is not provided BIASM).

Since transistors M11 655 and M12 660 are turned on by B_{trigger}, as previously discussed, CCK (at VGL at time 715) is provided to QBH node 671. Accordingly, since CCK is at VGL (e.g., −12 V), transistor M1 605 is turned off (i.e., output B(m) is not provided BIASH).

However, since transistors M7 635 and M8 645 are turned on by B_{trigger}, CCKB (at VGH at time 715) is provided to QBL node 670. Accordingly, transistor M3 610 is turned on, and therefore, BIASL (e.g., −8 V) is provided to B(m).

If CCKB and CCK were inverted, for example, by having CCK at VGH and CCKB at VGL at time 715, then transistor M1 605 is turned on to provide BIASH to output B(m).

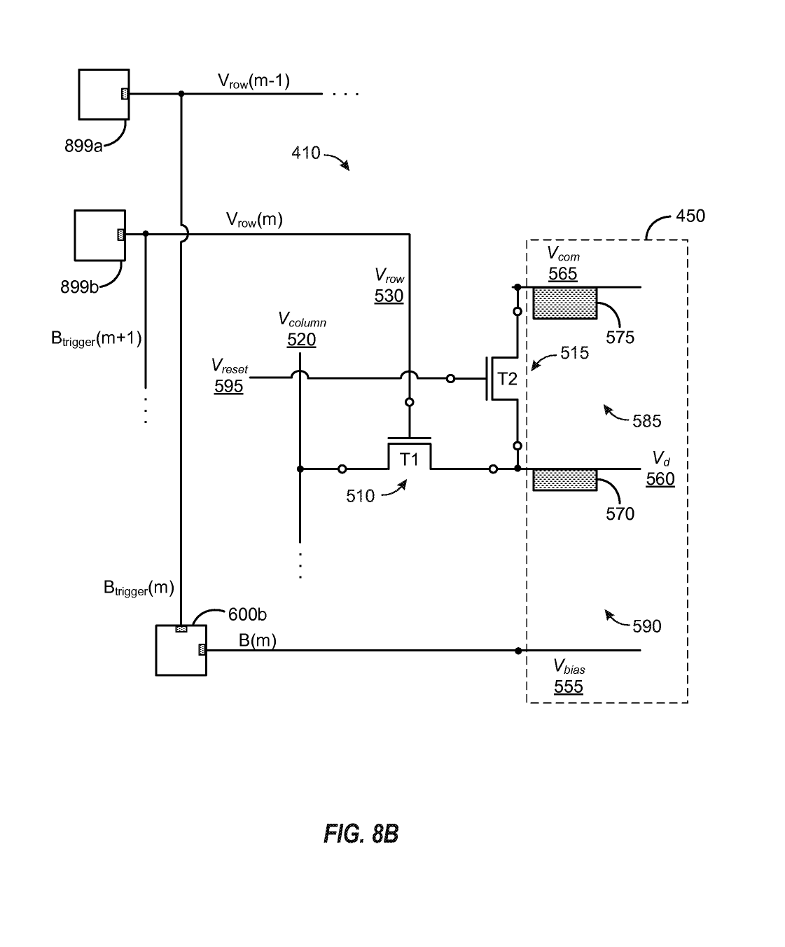

Output B(m) may be provided to V_{bias} electrode 555 of one or more display units 450 of display modules 410 in a row of display array 30, as in FIG. 4. B_{trigger} may be provided by a variety of different sources. For example, B_{trigger} may be provided by a prior row's V_{row} 530 providing a voltage between VGH and VGL. That is, a driver providing V_{row} 530 for display modules 710 in another row may also be used to provide B_{trigger} (e.g., V_{row} 530 of the prior row may be B_{trigger} for the row). FIG. 8A is an example of a system block diagram illustrating an output of a driver being used as a trigger for another driver. In FIG. 8A, driver circuits 600a, 600b, and 600c drive V_{bias} electrode 555 of display modules 410 of the respective rows. That is, driver circuit 600a drives V_{bias} electrode 555 for display modules 410 in the first row (i.e., the row associated with B(m−1), which is the row before the row associated with B(m)). Driver circuit 600b drives V_{bias}electrode 555 for display modules 410 in the second row (i.e., the row associated with B(m)). Driver circuit 600c drives V_{bias} electrode 555 for display modules 410 in the third row (i.e., the row associated with B(m+1), which is the row after the row associated with B(m)). Driver circuits 899a, 899b, and 899c provide V_{row} 530 (i.e., the voltage to be applied to the gate of transistor T1 510 of FIG. 5) for each display module 410 in the respective rows. However, V_{row}(m−1) provided by driver 899a (i.e., the driver providing V_{row} 530 for the first row of display modules 410) may also be used as B_{trigger} (i.e., B_{trigger}(m) in FIG. 8A) for driver circuit 600b providing B(m). That is, V_{row} 530 from a row may also be used as B_{trigger} for the next row of display modules 410 in display array 30. Likewise, V_{row}(m) may be used as B_{trigger} (i.e., B_{trigger}(m+1)) for driver circuit 600c providing B(m+1). B_{trigger} for driver circuit 600a (i.e., the first driver circuit providing B(m−1) for the first row) may be from other circuitry, or an external chip, also providing the clocks and power supplies. FIG. 8B is another example of a system block diagram illustrating an output of a driver being used as a trigger for another driver. FIG. 8B shows driver circuit 600b of FIG. 8A providing V_{bias} 555 for display unit 450, driver 899b providing V_{row}(m) for V_{row} 530, and driver 899a providing V_{row}(m−1) for a display unit in a prior row, but its output also being used as B_{trigger}(m) for display unit 450.

As another example, B_{trigger} may be a prior row's gate carry signal CaG(m−2) providing a voltage between VGH and VGLL. Ca(m) may be generated by a driver circuit providing a voltage for V_{row} 530 (provided by R(m)). U.S. patent application Publication Ser. No. 13/909,839, titled REDUCING FLOATING NODE LEAKAGE CURRENT WITH A FEEDBACK TRANSISTOR, by Kim et al., filed on Jun. 4, 2013, discloses circuits for generating voltages for V_{row} 530 and the gate carry signal, and is hereby incorporated by reference in its entirety and for all purposes. As another example, the preceding signals may also be provided by a subsequent row rather than a prior row.

Additionally, B_{trigger} may be a subsequent row's Vᵣₑₛₑₜ 595 providing a voltage between VGH and VGL. In another implementation, B_{trigger} may be a subsequent row's reset carry signal providing a voltage between VGH and VGLL.

R_{trigger} may be Vᵣₑₛₑₜ 595 of a prior row providing a voltage between VGH and VGL. In another implementation, R_{trigger} may be a previous row's reset carry signal (CaR(m−2) providing a voltage between VGH and VGLL. Accordingly, a variety of other signals from other driver circuits providing other signals to display modules 410 may be used as R_{trigger} and B_{trigger} signals for driver circuit 600. Using already existing signals may reduce driver circuitry, and therefore, reduce the area of the silicon die dedicated to driver circuitry.

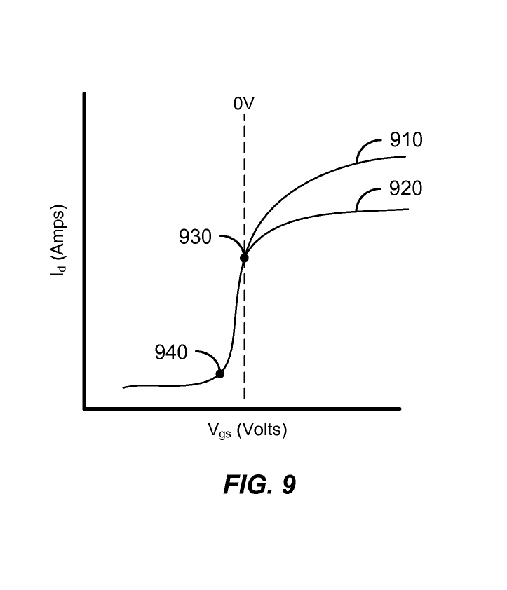

The power supply scheme may also be used to reduce the sub-threshold leakage of transistors M1 605, M3 610, M2 615, M6 630, and M10 650, and therefore, reduce static power consumption and lower power usage. FIG. 9 is an illustration of a transfer curve for I_{d} (drain current) vs. V_{gs} (gate-to-source voltage) for an exemplary NMOS transistor. In FIG. 9, curves 910 and 920 may represent two different V_{ds} (drain-to-source voltage) biases. For example, curve 910 may be associated with a V_{ds} of 10.1 V (Volts) and curve 920 may be associated with a V_{ds} of 0.1 V.

As seen in FIG. 9, I_{d} is lower at lower V_{gs} values. Some transistors, such as depletion mode field effect transistors, show a negative turn-on voltage (Vₒₙ) which is the V_{gs} where I_{d} starts to increase abruptly with increasing V_{gs}. For example, in FIG. 9, point 940 may be associated with a Vₒₙ of −1 V. Moreover, at point 930, or a 0 V V_{gs} bias, I_{d} may approximately be 1 nA (nanoampere) or higher.

Ideally, when V_{gs}<Vₜₕ (threshold voltage), such as at point 930 when V_{gs} is 0 V, an NMOS transistor should be turned off, and thus I_{d} should be 0 A. However, a sub-threshold leakage occurs, as indicated by the non-zero y-axis I_{d} of points 930 and 940 on the transfer curves of FIG. 9. The sub-threshold leakage may increase power consumption and/or interfere with the intended operation of a circuit.

Accordingly, biasing the V_{gs} of an NMOS transistor lower may reduce the sub-threshold leakage. That is, biasing V_{gs} at point 940, or any lower V_{gs} value, rather than point 930 at 0 V V_{gs}, reduces the I_{d} sub-threshold leakage. The power supply scheme for the driver circuit in FIG. 6 may provide a lower V_{gs} value for transistors M1 605, M2 615, M3 610, M6 630, and M10 650.

For example, when transistor M1 605 is turned off, its drain may be 8 V (i.e., BIASH is at 8 V) and its gate may be at −12 V (i.e., QBH node 671 may be biased to −12 V because QBL provided by CCK is at −12 V). Accordingly, V_{gs} of transistor M1 605 may be −20 V, and therefore, the sub-threshold leakage may be reduced because a lower V_{gs} is associated with a lower I_{d} on curves 910 and 920 in FIG. 9. Likewise, for transistor M3 610, V_{gs} may also be −20 V. The sub-threshold leakage at transistor M2 615 may also be reduced because its drain may be 0 V (provided by BIASM) and its gate may be at −12 V, providing a V_{gs} of −12 V.

If R_{trigger} is at VGLL rather than VGL, then sub-threshold leakage may also be reduced for transistors M6 630 and M10 650. Likewise, if B_{trigger} is at VGLL rather than VGL, then sub-threshold leakage may also be reduced for transistor M4 620.

The power supply scheme described above may improve the circuit robustness during the lifetime of the display. Even if the turn-on voltage is negative and has dispersion, the driver circuit functions well with the turn-on voltage within VGLL−VGL and VGL−BIASL. For example, if the turn-on voltage is higher than −4V, the sub-threshold leakage current is reduced by the power supply scheme.

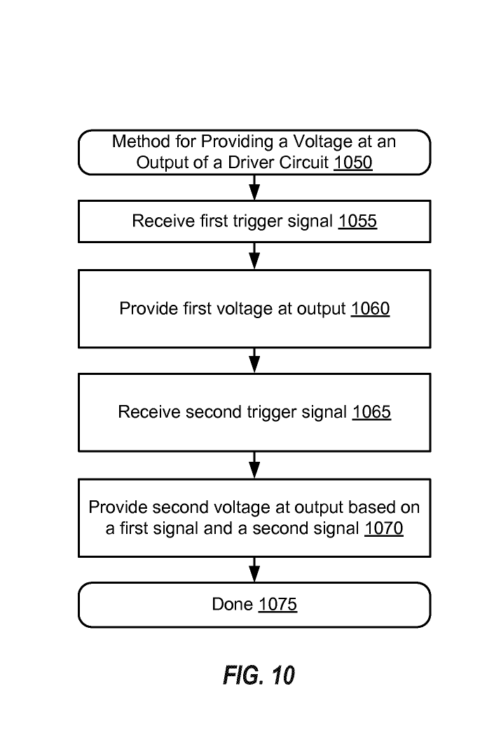

FIG. 10 is a flow diagram illustrating a method for providing a voltage at an output of a driver circuit. The voltage at the output may be provided to V_{bias} electrode 555 of display unit 450. In method 1050, at block 1055, a first trigger signal may be received. For example, R_{trigger} in driver circuit 600 may be asserted. At block 1060, a first voltage may be provided at an output. For example, output B(m) of driver circuit 600 may be pulled to BIASM (e.g., 0 V) when R_{trigger} is asserted. Accordingly, V_{bias} electrode 555 may be driven to 0 V by driver circuit 600. In some implementations, V_{com} electrode 565 may be grounded at 0 V. Additionally, Vᵣₑₛₑₜ 595 may be asserted so that V_{d} electrode 560 is coupled with V_{com} electrode 565, and therefore, is also at 0 V. As such, each of the three electrodes of display unit 450 may be at 0 V, indicating a reset state.

At block 1065, a second trigger signal may be received. For example, B_{trigger} in driver circuit 600 may be asserted. In block 1070, a second voltage may be provided at an output based on a first signal and a second signal. For example, if R_{trigger} is no longer asserted and B_{trigger} is asserted, either BIASH (e.g., 8 V) or BIASL (e.g., −8 V) may be provided at output B(m) of driver circuit 600 based on which of CCK and CCKB (e.g., if CCKB is at VGH and CCK is at VGL, then output B(m) provides BIASL). Accordingly, the voltage at V_{bias} electrode 555 may switch from 0 V to either 8 V or −8 V. The method ends at block 1075.

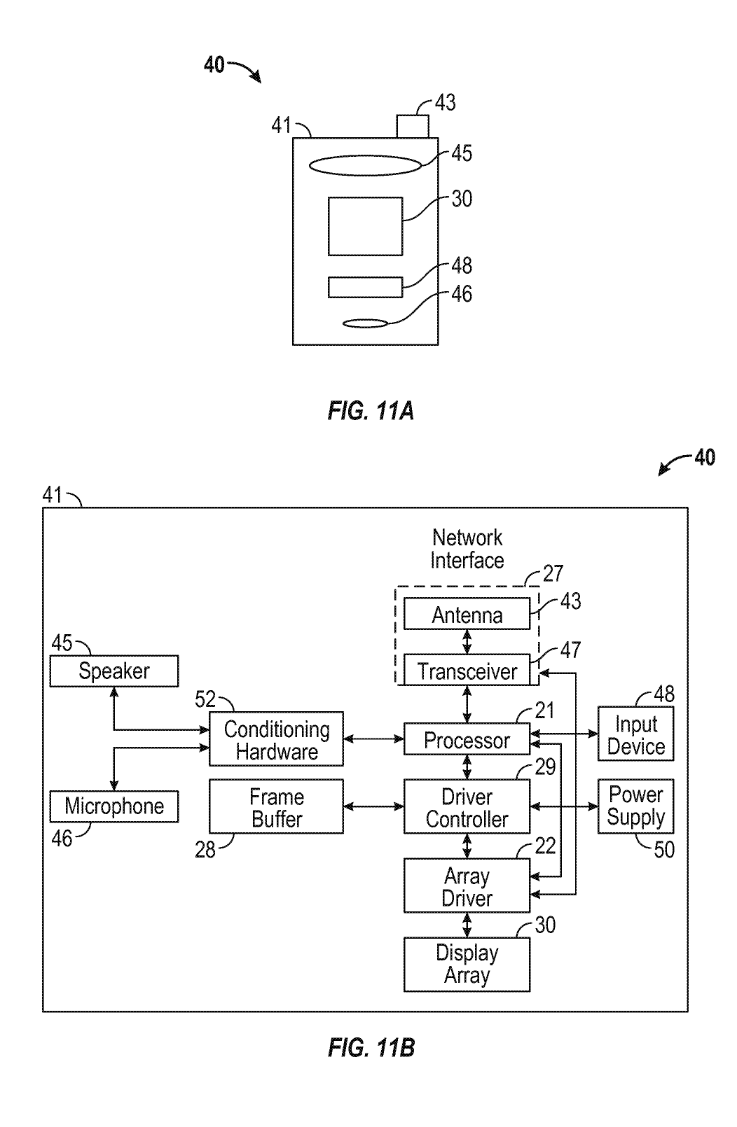

FIGS. 11A and 11B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 11A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The circuits and techniques disclosed herein utilize examples of values (e.g., voltages) that are provided for illustration purposes only. Other implementations may involve different values.

What is claimed is:

1. A circuit comprising:
output circuitry including a first output driver, a second output driver, and a third output driver, each of the output drivers coupled together to define an output node, the first output driver capable of driving the output node to a first voltage associated with a first voltage source, the second output driver capable of driving the output node to a second voltage associated with a second voltage source, and the third output driver capable of driving the output node to a third voltage associated with a third voltage source; and
selection circuitry capable of selecting one of the first output driver, the second output driver, and the third output driver to drive the output node, the selection circuitry receiving a first input signal, a second input signal, a first trigger, and a second trigger, the selection circuitry capable of selecting the output driver to drive the output node based on the first input signal, the second input signal, the first trigger, and the second trigger.

2. The circuit of claim 1, wherein the output circuitry includes:
the first output driver having a first switch, the first switch having a control terminal, a first terminal and a second terminal, the first terminal coupled with a first voltage source;
the second output driver having a second switch, the second switch having a control terminal, a first terminal and a second terminal, the first terminal coupled with a second voltage source, the second terminal of the first switch coupled with the second terminal of the second switch to define the output node; and
the third output driver having a third switch, the third switch having a control terminal, a first terminal, and a second terminal, the first terminal coupled with a third voltage source, the second terminal coupled with the output node.

3. The circuit of claim 2, wherein the selection circuitry includes:
a fourth switch having a control terminal, a first terminal, and a second terminal, the first terminal coupled with a fourth voltage source, the second terminal coupled with the control terminal of the first switch, and the control terminal of the third switch coupled to receive the first trigger signal,
a fifth switch having a control terminal, a first terminal, and a second terminal, the first terminal coupled with the fourth voltage source, the second terminal coupled with the control terminal of the second switch, and the control terminal of the fourth switch coupled to receive the first trigger signal, and
a sixth switch having a control terminal, a first terminal, and a second terminal, the first terminal coupled with the fourth voltage source, the second terminal coupled with the control terminal of the third switch, and the control terminal coupled to receive the second trigger signal.

4. The circuit of claim 1, further comprising:
a display including a plurality of display units, wherein a voltage at the output node of the output circuit is provided to an electrode of at least one display unit;
a processor that is capable of communicating with the display, the processor being configured to process image data; and
a memory device that is capable of communicating with the processor.

5. The circuit of claim 4, further comprising:
a controller capable of sending at least a portion of the image data to the driver circuit.

6. The circuit of claim 4, further comprising:
an image source module capable of sending the image data to the processor, wherein the image source module comprises at least one of a receiver, transceiver, and transmitter.

7. The circuit of claim 4, further comprising:
an input device capable of receiving input data and to communicate the input data to the processor.

8. A circuit comprising:
output circuitry including:
a first switch having a control terminal, a first terminal and a second terminal, the first terminal coupled with a first voltage source,
a second switch having a control terminal, a first terminal and a second terminal, the first terminal coupled with a second voltage source, the second terminal of the first switch coupled with the second terminal of the second switch to define an output node, and
a third switch having a control terminal, a first terminal, and a second terminal, the first terminal coupled with a third voltage source, the second terminal coupled with the output node; and
selection circuitry including:
a fourth switch having a control terminal, a first terminal, and a second terminal, the first terminal coupled with a fourth voltage source, the second terminal coupled with the control terminal of the first switch, and the control terminal of the third switch coupled to receive a first trigger signal,
a fifth switch having a control terminal, a first terminal, and a second terminal, the first terminal coupled with the fourth voltage source, the second terminal coupled with the control terminal of the second switch, and the control terminal of the fourth switch coupled to receive the first trigger signal, and
a sixth switch having a control terminal, a first terminal, and a second terminal, the first terminal coupled with the fourth voltage source, the second terminal coupled with the control terminal of the third switch, and the control terminal coupled to receive a second trigger signal.

9. The circuit of claim 8, wherein the first voltage source is capable of providing a voltage higher than a voltage provided by the third voltage source, and the voltage provided by the third voltage source is higher than a voltage provided by the second voltage source.

10. The circuit of claim 9, wherein the voltage provided by the second voltage source is higher than a voltage provided by the fourth voltage source.

11. The circuit of claim 10, wherein the first trigger signal is capable of providing a voltage between a first voltage and a second voltage, the first voltage higher than the voltage provided by the first voltage source, and the second voltage lower than the voltage provided by the fourth voltage source.

12. The circuit of claim 10, wherein the second trigger signal is capable of providing a voltage between a first voltage and a second voltage, the first voltage higher than the voltage provided by the first voltage source, and the second voltage lower than the voltage provided by the fourth voltage source.

13. The circuit of claim 8, wherein the first voltage source is capable of providing a voltage higher than a voltage provided by the third voltage source, the voltage provided by the third voltage source is higher than a voltage provided by the second voltage source, and the voltage provided by the second voltage source is higher than a voltage provided by the fourth voltage source.

14. The circuit of claim 13, wherein the first trigger signal is capable of providing a voltage between a first voltage and a second voltage, the first voltage higher than the voltage provided the first voltage source, and the second voltage is lower than the voltage provided by the fourth voltage source.

15. The circuit of claim 8, wherein the selection circuitry further includes:
a seventh switch having a control terminal, a first terminal, and a second terminal, the first terminal coupled with the control terminal of the first switch to define a first feedback node, and the control terminal coupled to receive the second trigger signal;
an eighth switch having a control terminal, a first terminal, and a second terminal, the first terminal coupled to receive a first input signal, the second terminal coupled with the second terminal of the seventh switch, and the control signal coupled to receive the second trigger signal; and
a ninth switch having a control terminal, a first terminal, and a second terminal, the first terminal coupled with a fifth voltage source, the second terminal coupled with the second terminals of the seventh switch and the eighth switch, and the control terminal coupled with the first feedback node.

16. The circuit of claim 15, wherein the fifth voltage source is capable of providing a voltage higher than a voltage provided by the first voltage source, the voltage provided by the first voltage source higher than a voltage provided by the third voltage source, the voltage provided by the third voltage source higher than a voltage provided by the second voltage source, and the voltage provided by the second voltage source higher than a voltage provided by the fourth voltage source.

17. The circuit of claim 16, wherein the first trigger signal is capable of providing a low voltage, the low voltage lower than the voltage provided by the fourth voltage source.

18. The circuit of claim 15, wherein the selection circuitry further includes:
a tenth switch having a control terminal, a first terminal, and a second terminal, the first terminal coupled with the control terminal of the second switch to define a second feedback node, and the control terminal coupled to receive the second trigger signal;
an eleventh switch having a control terminal, a first terminal, and a second terminal, the first terminal coupled to receive a second input signal, the second terminal coupled with the second terminal of the tenth switch, and the control signal coupled to receive the second trigger signal; and
a twelfth switch having a control terminal, a first terminal, and a second terminal, the first terminal coupled with the fifth voltage source, the second terminal coupled with the second terminals of the tenth switch and the eleventh switch, and the control terminal coupled with the second feedback node.

19. The circuit of claim 18, wherein the selection circuitry further includes:
a thirteenth switch having a control terminal, a first terminal, and a second terminal, the first terminal coupled with the control terminal of the third switch, the second terminal coupled with the fifth voltage source, and the control terminal coupled to receive the first trigger signal.

20. A method comprising:
receiving a first trigger signal;
providing, responsive to the first trigger signal, a first voltage at an output node of output circuitry, and the output node is electrically coupled to an electrode of a display unit;
receiving a second trigger signal; and
providing, responsive to the second trigger signal, a second voltage or a third voltage at the output node based on a first input signal and a second input signal.

21. The method of claim 20, further comprising:
selecting, by selection circuitry, the first voltage, second voltage, or third voltage to be provided at the output node, wherein the output circuitry includes:
a first switch having a control terminal, a first terminal and a second terminal, the first terminal coupled with a first voltage source,
a second switch having a control terminal, a first terminal and a second terminal, the first terminal coupled with a second voltage source, the second terminal of the first switch coupled with the second terminal of the second switch to define the output node, and
a third switch having a control terminal, a first terminal, and a second terminal, the first terminal coupled with a third voltage source, the second terminal coupled with the output node;
and wherein the selection circuitry includes:
a fourth switch having a control terminal, a first terminal, and a second terminal, the first terminal coupled with a fourth voltage source, the second terminal coupled with the control terminal of the first switch, and the control terminal of the third switch coupled to receive the first trigger signal,
a fifth switch having a control terminal, a first terminal, and a second terminal, the first terminal coupled with the fourth voltage source, the second terminal coupled with the control terminal of the second switch, and the control terminal of the fourth switch coupled to receive the first trigger signal, and
a sixth switch having a control terminal, a first terminal, and a second terminal, the first terminal coupled with the third voltage source, the second terminal coupled with the control terminal of the third switch, and the control terminal coupled to receive the second trigger signal.

22. The method of claim 20, wherein the first input signal and the second input signal provide a voltage between a fourth voltage and a fifth voltage, the first trigger signal and the second trigger signal provide a voltage between the fourth voltage and a sixth voltage.

23. The method of claim 22, wherein the fourth voltage is higher than the second voltage, the second voltage is higher than the first voltage, the first voltage is higher than the third voltage, the third voltage is higher than the fifth voltage, and the fifth voltage is higher than the sixth voltage.
